(19) United States
(12) Patent Application Publication
(10) Pub. No.: US 2009/0147630 A1
(43) Pub. Date: Jun. 11, 2009

(54) PUSH-BUTTON CONTROL DEVICE

(75) Inventors: Nicolas Clerc, Le Locle (CH); David Apotheloz, Corcelles (CH)

Correspondence Address: GRIFFIN & SZIPL, PC, SUITE PH-1, 2300 NINTH STREET, SOUTH, ARLINGTON, VA, 22204, US

(73) Assignee: TISSOT S.A., Le Locle (CH)

(21) Appl. No.: 12/325,045

(22) Filed: Nov. 28, 2008

(30) Foreign Application Priority Data
Nov. 28, 2007 (EP) 07121716.0

(51) Int. Cl. G04B 37/12

(52) U.S. Cl. 368/290

(57) ABSTRACT

The present invention concerns a push-button control device for a timepiece, including a push-button head secured to a push-button stem that is fixed to a timepiece case, said stem being able to move axially between at least a rest position and an active position, against a return member, to control at least one function of said timepiece, and water-resistant sealing means, said device being characterized in that the water-resistant sealing means include a cap made of flexible, water-resistant material which covers the push-button head and which is secured to the timepiece case.

This application claims priority from European Patent Application No. 07121716.0, filed Nov. 28, 2007, the entire disclosure of which is incorporated herein by reference.

### FIELD OF THE INVENTION

The present invention relates to the field of watchmaking. It concerns more specifically a water resistant push-button control device for a watch.

### BACKGROUND OF THE INVENTION

Push-button devices control various functions in timepieces. Typically, the start, stop and reset functions of a chronograph watch are controlled by these devices, which are mounted on the middle part of the watchcase.

Conventionally, push-button control devices include a push-button tube that is fixed to the middle part of the watch, in an aperture therein. A push-button stem, associated with a push-button head, is arranged inside the tube so that it can slide axially therein, between a rest position and an active position, against the force of a return spring. The surface of the push-button head that faces the middle part includes an annular recess defining a skirt, which surrounds a central cylindrical portion, to which the stem is attached. The width of the recess is such that it can receive the distal end of the push-button head, which slides therein. O-ring sealing gaskets that seal the tube in a water resistant manner are arranged on the side of the push-button head between the stem and the tube. This type of device can be activated very easily by the person wearing the timepiece to carry out a command associated with a watch function. This type of device is disclosed for example in CH Patent No. 457 291.

It has been observed that the water resistance of this type of push-button is not entirely satisfactory for dive watches. Indeed, during deep dives, the O-ring gaskets can be subjected to pressure that is so high, typically of the order of several dozen atmosphere, that they can no longer ensure the required level of water resistance.

In order to increase the level of guaranteed water resistance, a larger sealing gasket could be inserted into the device. However, if such a gasket is inserted, or if several gaskets are inserted in the type of construction described above, the friction between the gaskets and the guide tube greatly increases and there is a risk that the tube will not return to its rest position because of this friction once the pressure on the push-button head has ceased.

To try to overcome this drawback, CH Patent No. 560 923 proposed enlarging the part of the tube located outside the case, so that the push-button head can be partly housed therein, and covering the push-button head that partially projects from the tube with a bell-shaped elastic membrane. The tube includes a central section on either side of which extend a distal section and a proximal section, which both have a smaller diameter than the diameter of the central section, to define a distal shoulder surface and a proximal shoulder surface. The proximal section is threaded and is screwed into a bore in the middle part, with a sealing gasket inserted between the external surface of the middle part and the proximal shoulder surface. The central section is also threaded, whereas the distal section is smooth. The elastic membrane includes a central part from which there extends an annular wall, extended by a peripheral edge that has the shape of an annular side strip. The height of the side strip is greater than its width. The edge is compressed between the distal shoulder surface and an inner shoulder surface of a ring, which is screwed onto the central section of the tube. The central part of the membrane is free, allowing the push-button head to be acted upon.

This construction, however, still has drawbacks. First of all, it cannot be used with conventional push-buttons, i.e. push-buttons with a head sliding around a smooth bent tube, since the tube has to be adapted in order for the ring to be secured thereto. This solution is not, therefore, economical. Moreover, given the shape of the peripheral edge of the membrane, if the ring is tightened too vigorously onto the tube, this may buckle the edge and thus compromise the desired water resistance.

A watchcase provided with two push-buttons and surrounded by a peripheral, flexible, rubber ring, arranged between the middle part and the bezel, is also known from CH Patent No. 676 186. The ring covers the push-buttons, but the flexibility of the rubber still allows them to be operated. The ring also protects the watch against shocks and ensures the water resistance of the push-buttons.

This Patent has the drawback of concealing the push-buttons and requiring the entire watchcase to be dismantled in the event that the ring needs to be changed, which thus involves consulting a watchmaker. Moreover, the entire ring has to be changed, which makes replacement uneconomical.

### SUMMARY OF THE INVENTION

It is an object of the present invention to overcome the aforementioned drawbacks, in addition to others, by providing a push-button control device of simple and economical construction, which has improved water-resistant properties even in deep dive conditions.

It is also an object of the invention to provide a highly water-resistant push-button control device of this type that uses conventional push-buttons that are readily available on the market.

It is also an object of the invention to provide a push-button control device of this type whose structure gives the watch a new and attractive aesthetic appearance.

The invention therefore concerns a push-button control device as defined in claim 1.

### BRIEF DESCRIPTION OF THE DRAWINGS

Other features and advantages of the present invention will appear more clearly from the following detailed description of an example embodiment of a push-button control device according to the invention, this example being given purely by way of non-limiting illustration, with reference to the annexed drawing, in which.

FIG. 1 is a perspective view of a timepiece, whose case is fitted with a plurality of push-button control devices according to the invention,

FIG. 2 is a similar view to FIG. 1, in which the push-button control device of the invention is shown in a partially exploded view, and

FIG. 3 is a partial cross-section along the median plane of the timepiece case of FIG. 1 showing the push-button control device according to the invention.

### DETAILED DESCRIPTION OF THE ILLUSTRATIVE EMBODIMENTS

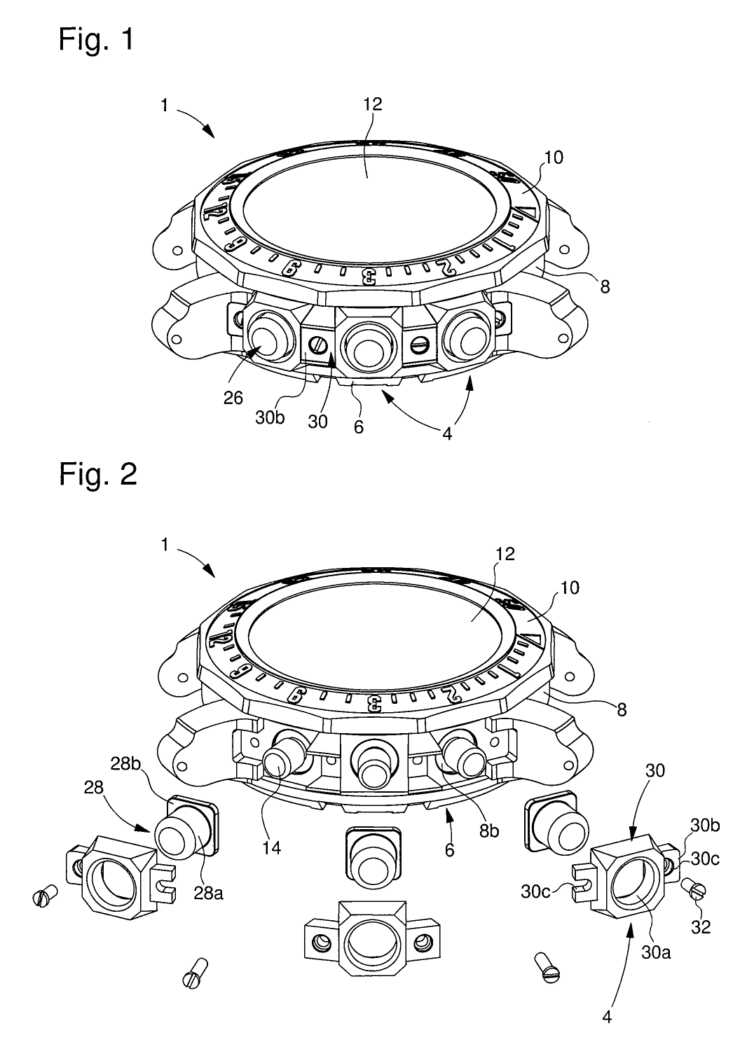

FIGS. 1 and 2 show a timepiece, in this case a wristwatch, designated by the general reference 1, whose case is fitted with a plurality of push-button control devices 4. In this example, there are three push-button devices.

The case is comprised, in a conventional manner, of a back cover 6, a middle part 8 and a bezel 10, closed by a crystal 12. The case thus defines a housing for a timepiece movement (not shown), which includes various mechanisms associated with functions that can be activated respectively by the push-button control devices 4.

Each push-button control device 4 includes a push-button head 14 secured to a push-button stem 16, which passes through a guide tube 18, mounted on middle part 8 and projecting from said middle part. Typically, tube 18 has a shoulder and is directly driven into a bore 8a in middle part 8. Alternatively, tube 18 may also be screwed onto the middle part with the insertion of a sealing gasket between the shoulder surface of the tube and the middle part. It should also be noted in this respect that, in the example illustrated, middle part 8 includes a circular recess 8b, which extends around bore 8a for receiving part of the water-resistant sealing means which will be described below.

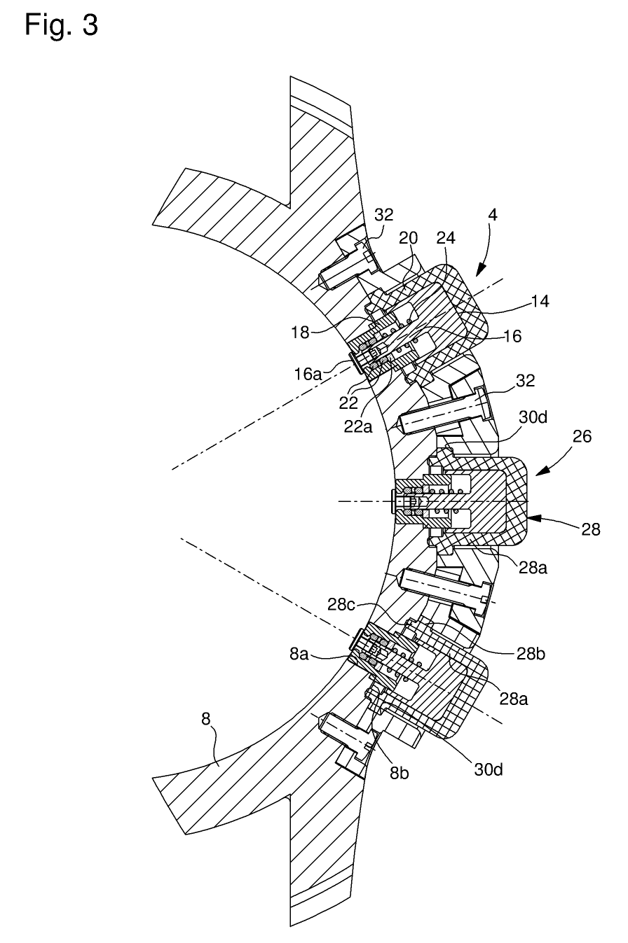

Referring also to FIG. 3, it can be seen that push-button head 14 partially envelopes tube 18 via skirt 20 of head 14, which fits onto the top end of the tube. Head 14 has a central cylindrical core, which extends axially to form push-button stem 16. A sealing gasket 22 is arranged between tube 18 and stem 16 and it is held in place by a washer 22a. Device 4 is completed by a cylindrical return spring 24, arranged between washer 22a and push-button head 14, for returning said head towards the exterior. Stem 16 can thus move axially between at least a rest position and an active position against spring 24, so as to control, via the free end thereof, one function of the timepiece movement. When one presses on head 14, this compresses spring 24 and skirt 30 partially penetrates the housing 8b, which is made in middle part 8. The head of push-button 14 is held in place on tube 18 by means of a screw 16a, secured to the end of stem 16.

Push-button control device 4 further includes sealing means 26 for making the timepiece case water-resistant as regards the exterior.

Sealing means 26 include a cap 28 made of flexible, water-resistant material, which covers push-button head 14 and which is secured to the timepiece. Typically, the cap is made of rubber, however, it could be made of any other flexible, water-resistant material, such as silicon, or any other material derived from these two materials or having similar properties.

Cap 28 includes a body 28a of generally cylindrical shape and, in the area of its aperture, a peripheral collar or edge 28b, which extends into a substantially perpendicular plane to the axis of cylinder. In the example illustrated, the collar is extended in the axial direction of the cap by a circular lip 28c, which extends substantially in alignment with body 28a. The diameter of lip 28c is substantially equal to the diameter of circular recess 8b and the length of lip 28c along the axis of the cap is substantially larger than the depth of circular recess 8b. It goes without saying that, in a variant of the invention that is not shown, lip 28c could be omitted.

The cap is sized to surround and completely cover push-button head 14 and the part of tube 18 that projects from the middle part. Cap 28 can thus envelope the push-button head and the tube and abut, via its collar 28b, against middle part 8 to seal device 4 in a water-resistant manner. More specifically, and as appears more clearly in FIG. 3, cap 28 is applied against middle part 8, so that lip 28c is housed and fitted into circular recess 8c, such that it is held slightly compressed against the bottom of recess 28c. In order to do this, the device includes a securing ring 30 that is directly fixed to middle part 8 to compress collar 28b of the cap against the middle part. Securing ring 30 includes a cylindrical passage 30a, through which the cap projects, and at lest one securing lug 30b, provided with a passage 30c for a screw 32 that is directly screwed into middle part 8. It will be noted that the dimensions of passage 30a are such that there is sufficient play, between the inner wall of the passage and the outer wall of the body of the cap, for the body to be able to deform laterally when the push-button head is pressed. In the example shown, securing ring 30 of each device 4 includes two diametrically opposite securing lugs 30b, lugs 30b being aligned along the circumferential direction of middle part 8. In the embodiment illustrated, securing ring 30 is provided with an inner shoulder 30d, which defines a housing for receiving collar 28b. It will be noted in this regard that the axial depth of the housing is slightly smaller than the thickness of the collar, so that the collar can be compressed when securing screws 32 are tightened onto middle part 8.

Although the present invention has been described in relation to particular embodiments, it is clear that it is not limited to said examples and that it is capable of numerous variants and alterations without departing from the scope of the invention.

1. A push-button control device for a timepiece, including a push-button head secured to a push-button stem that is fixed to a timepiece case, said stem being able to move axially between at least a rest position and an active position against a return member to control at least one function of said timepiece, and water-resistant sealing means, said device being wherein the water-resistant sealing means include a cap made of flexible, water-resistant material which covers the push-button head and which is secured to the timepiece case.

2. The control device according to claim 1, wherein the push-button stem passes through a guide tube that is fixed in the case and projects from said case and wherein the cap surrounds and covers the push-button head and the part projecting from the tube.

3. The control device according to claim 1, wherein said cap includes, in the area of the aperture thereof, a collar via which said cap abuts against said timepiece case.

4. The control device according to claim 3, wherein the cap has a body of generally cylindrical shape and wherein the collar extends in a substantially perpendicular plane to the cylinder axis.

5. The control device according to claim 4, wherein the collar is extended in the axial direction of the cap by a circular lip, which extends substantially in alignment with the body of the cap.

6. The control device according to claim 3, wherein said cap is held compressed against the case via the collar by means of a securing ring that is fixed directly to the timepiece case.

7. The control device according to claim 6, wherein said securing ring includes a cylindrical passage, through which the cap projects, and at least one securing lug.

8. The control device according to claim 7, wherein said securing ring includes two diametrically opposite securing lugs.

9. The control device according to claim 7, wherein said securing ring is provided with an inner shoulder defining a housing for receiving said collar.

10. The control device according to claim 7, wherein the securing lug or lugs are directly screwed onto the case.

11. The control device according to claim 1, wherein the cap is made of rubber or silicon.

12. The control device according to claim 2, wherein said cap includes, in the area of the aperture thereof, a collar via which said cap abuts against said timepiece case.

13. The control device according to claim 8, wherein said securing ring is provided with an inner shoulder defining a housing for receiving said collar.
